(19) United States
(12) Patent Application Publication
(10) Pub. No.: US 2014/0067727 A1
(43) Pub. Date: Mar. 6, 2014

(54) Systems And Methods For Identifying The Service Needs Of A Retail Customer

(71) Applicants: Lynne Greene, New York, NY (US); Anthony Battaglia, Forest Hills, NY (US)

(72) Inventors: Lynne Greene, New York, NY (US); Anthony Battaglia, Forest Hills, NY (US)

(21) Appl. No.: 13/597,393

(22) Filed: Aug. 29, 2012

(51) Int. Cl. G06Q 90/00

(52) U.S. Cl. CPC G06Q 90/00
USPC 705/500

(57) ABSTRACT

Systems and methods are provided for identifying and communicating the service needs of a retail customer to a sales associate in a retail setting. The systems and methods employ an article or articles which allow the customer to select and communicate a desired level of service to the sales associate.

### BACKGROUND OF THE INVENTION

1. Field of the Invention

The present invention relates to systems and methods for personalizing customer service in a retail setting. In particular, the present invention is directed to systems and methods for identifying the service needs of a retail customer and communicating the customer's service needs to a sales associate so as to receive the level of service desired by an individual customer.

2. Description of the Prior Art

Retail shopping, and in particular, shopping in a beauty department for skin care, makeup, fragrance, and the like, can be a discomforting experience for many consumers. At times, a retail customer may approach a beauty counter hoping to quickly snag the attention of a beauty consultant or advisor, and make a hasty retreat with her purchases, only to be watched and pursued by an overzealous sales associate trying to sell the customer the latest product and/or to meet her weekly sales targets. At other times, it can be equally perturbing when the shopper wishes to receive beauty advice or has questions about a purchase but can't get the attention of a beauty advisor. Traditionally, retail settings, and, in particular, those dedicated to the sale of cosmetic products, have employed a conventional counter design with beauty consultants standing behind a case and customers lined up in front of the case waiting in turn for assistance. Newer shopping methods have included an open space design (“open sell” environment), including hands-on product displays and testers, enabling the clientele to select and/or experiment with products without the inconvenience of needing to find a member of the sales team who can retrieve the product for her from behind the counter. Other sales methods have employed an express window service for those patrons with little time to spare, or the use of a basket for those who wish merely to browse at their leisure. However, there is still a need for a customized sales approach which strikes the right balance in the retail setting and which gives the customer control over her shopping experience, eliminating the aforementioned problems.

### BRIEF SUMMARY OF THE INVENTION

The present invention provides a method for improving retail customer service by identifying and communicating to a sales associate the service needs of a retail customer in a retail setting, the method comprising:
(a) providing a choice of at least two articles to the retail customer, wherein each of the at least two articles is adapted to designate a different level of customer service which may be desired by the retail customer; and
(b) providing instructions to the retail customer to (1) select one of the at least two articles which best defines the service needs of the retail customer at the time of the selection, and (2) prominently display on, or otherwise associate the article with, the retail customer's person so as to communicate the retail customer's service needs to a sales associate and receive the desired level of customer service from the sales associate.

The present invention also concerns a method for improving retail customer service by identifying and communicating to a sales associate the service needs of a retail customer in a retail setting, the method comprising:
(a) providing an article to the retail customer, the article being adapted to designate at least two levels of customer service available to the retail customer;
(b) enabling the retail customer to select one of the at least two levels of customer service designated by the article which best defines the customer service needs of the retail customer at the time of the selection; and
(c) providing instructions to the retail customer to prominently display, or otherwise associate, the article designating the selected level of service with the retail customer's person so as to communicate the level of service desired by the retail customer to a sales associate and receive the desired level of service.

The present invention is also directed to a system for improving retail customer service by identifying and communicating to a sales associate the service needs of a retail customer in a retail setting, the system comprising:
(a) at least two articles, each of which is adapted to designate a different level of customer service which may be desired by the retail customer; and
(b) instructions directed to the retail customer to (1) select one of the at least two articles which best defines the service needs of the retail customer at the time of the selection, and (2) prominently display on, or otherwise associate the article with, the retail customer's person so as to communicate the retail customer's service needs to a sales associate and receive the desired level of customer service from the sales associate.

The present invention is further directed to a system for improving retail customer service by identifying and communicating to a sales associate the service needs of a retail customer in a retail setting, the system comprising:
(a) an article adapted to designate at least two levels of customer service available to the retail customer;
(b) means associated with the article for enabling the retail customer to select one of the levels of customer service designated by the article which best defines the customer service needs of the retail customer at the time of the selection; and
(c) instructions directed to the retail customer to prominently display, or otherwise associate, the article designating the selected level of service with the retail customer's person so as to communicate the level of service desired by the retail customer to a sales associate and receive the desired level of service.

Other aspects and objectives of the present invention will become more apparent from the ensuing description, examples, and claims.

### BRIEF DESCRIPTION OF THE DRAWINGS

FIG. 1 depicts a display unit, in accordance with the present invention, having multiple compartments provided with instructions for selecting one of three differently colored wristbands contained in separate compartments in the display unit, each of the wristbands designating a different level of customer service available to a customer;

FIG. 2 is a perspective view of a first wristband shown in FIG. 1, having text thereon corresponding to a first level of service available to a customer;

FIG. 3 is a perspective view of a second wristband shown in FIG. 1, having text thereon corresponding to a second level of service available to a customer;

FIG. 4 is a perspective view of a third wristband shown in FIG. 1, having text thereon corresponding to a third level of service available to a customer;

FIG. 5 depicts a magnetic lapel pin, in accordance with the present invention, with an array of light bulbs and a touch screen display.

### DETAILED DESCRIPTION OF THE PREFERRED EMBODIMENTS OF THE INVENTION

Cosmetic areas in department stores can be intimidating for shoppers, whether the shopper knows exactly what she wants or whether she requires assistance in selecting the product or products which are specifically suited to her. Shoppers are individuals who also have different moods and are desirous of different levels of service at different times. When a shopper knows what she wants, she doesn't want to stand on line, sit for a demonstration of a new product, or be sold other products which are touted to improve the efficacy of the product she wants to buy. She merely wants to “grab and go” and interact with a sales associate only when she is ready to pay. At other times, a customer may wish to shop in an environment in which she is uninhibited and where she may experiment with products without interference from a salesperson. There are also times when a shopper may have questions or is desirous of a full consultation. But, until recently, there has not been a way for a sales associate to read the mind of a shopper and determine the level of service she requires without the necessity of interacting with her. Sales associates have traditionally used a “one-on-one” sales method which typically has involved a beauty advisor descending upon a customer and touting the benefits of a new product, and which has often provided the beauty advisor with opportunities to practice “up-selling”, or attempting to persuade the customer looking for one product that she also needs to purchase other products.

With the aim of improving the shopping experience, there has, in recent years, been a shifting away from one-on-one selling in cosmetic department retail settings. Additionally, while some cosmetic departments are still committed to employee-focused (or commission-based) selling, others have been focusing on ways to give the shopper a low pressure and more pleasant shopping experience, such as provided using the open selling method which enables a customer to test and select products without the aid of a salesperson.

The present invention provides an innovative, multi-level service which takes the individual customer's unique shopping style and preferences into consideration to suit each and every need and mood. One advantage is a more rewarding experience for both the individual and the sales associate.

According to a first embodiment of the present invention, a method is provided for improving retail customer service by identifying and communicating to a sales associate the service needs of a retail customer in a retail setting, the method comprising:
(a) providing a choice of at least two articles to the retail customer, wherein each of the at least two articles is adapted to designate a different level of customer service which is available to the retail customer; and
(b) providing instructions to the retail customer to (1) select one of the at least two articles which best defines the service needs of the retail customer at the time of the selection, and (2) prominently display on, or otherwise associate the article with, the retail customer's person so as to communicate the retail customer's service needs to a sales associate and receive the desired level of customer service from the sales associate.

Useful articles may include, but are not limited to, wristbands, pins, tags, buttons, badges, lanyards, pendants, caps, hats, headbands, scarves, baskets, totes, charms attachable to a mobile device, cards attachable on a key ring, and the like. In a preferred embodiment of the invention, the articles are wristbands. In a further preferred embodiment of the invention, three articles, designating three different levels of customer service, are provided. In yet another preferred embodiment of the invention, the articles have different colors or shapes from one another, the different colors or the different shapes each designating a different level of service available to the customer. The articles may be further provided with text which describes the retail customer's service needs.

In some embodiments of the present invention, instructions for selecting and displaying the article may be provided by a sales associate. In other embodiments of the present invention, the articles are contained in a display unit, either free-standing, or placed on a store counter, so as to be readily accessible to the customer. Preferably, the display unit is provided with instructions, which may be printed on the display unit, or otherwise be associated with display unit, such as provided on a sign placed near the display unit, permitting shoppers to self-select an article which, when prominently displayed by the shopper, will immediately identify her service needs and communicate those needs to the sales associate. In some embodiments of the present inventions, instructions for selecting the level of customer service may be provided on the article itself. It will be appreciated that part or all of the method may be carried out substantially non-verbally; that is, with minimal or no interaction between the retail customer and the sales associate.

It also will be appreciated that prominent display of the selected article by the shopper may include wearing, carrying, or any other means, such that the article will be visible to the sales associate and will communicate to the sales associate the level of service desired by the customer; that is, to either attract a sales associate or to avoid enthusiastic sales associates, as needed. Depending on her changing mood or needs while shopping, a customer may return to the display unit or to a sales associate and readily exchange the article she displays for another which designates and communicates her current service needs.

As a non-limiting example, one method according to the invention may employ three levels of service available to customers. A first level of service may be one in which the shopper is browsing leisurely, testing products at interactive product bars or displays, and desires no interaction with the sales associate unless and until the shopper wishes to make a purchase—a substantially salesperson-free shopping experience. The shopper who wishes no interaction with a sales associate may also take advantage of access to a manual or computer-aided diagnostic tool, in particular, a computer-aided diagnostic tool which is designed to allow the customer immediate access to on-on-one service to identify her skin care concerns by browsing a computer-guided skin care analysis program and receiving a printout (or an email) with custom-fit recommendations, all by answering a few key questions. A second level of service may be one available to customers desiring express service from a sales associate, such as when the customer is short of time, and, for example, knows exactly what she wants. She may have used up a product and merely wants to purchase more. She may have a question about her selection or the use of a product. For customers who have an abundance of time, a third level of service involving an extended interaction with a sales associate would be desirable. For those customers, a one-on-one consultation with a skin care specialist can provide the shopper with an expert skin care analysis, individualized recommendations for skin care and makeup products, and application techniques and tips.

According to a second embodiment of the present invention, a method is provided for improving retail customer service by identifying and communicating to a sales associate the service needs of a retail customer in a retail setting, the method comprising:
(a) providing an article to the retail customer, the article being adapted to designate at least two levels of customer service available to the retail customer;
(b) enabling the retail customer to select one of the two levels of customer service designated by the article which best defines the customer service needs of the retail customer at the time of the selection; and
(c) providing instructions to the retail customer to prominently display, or otherwise associate, the article designating the selected level of service with the retail customer's person so as to communicate the level of service desired by the retail customer to a sales associate and receive the desired level of service.

Any article, including those articles mentioned hereinabove, which has the capability of designating at least two levels of customer service may be employed in carrying out the method of the invention. As an example, any article that is switchable or flippable, such as a badge that is green on one side or pink on the other could be used. In particular, mention may be made of “e-tags”—electronic buttons, badges, tags, pins, for example, lapel pins, clutch pins, safety pins, and the like, with lights, light-emitting diodes (LEDs) in varying colors, or varying displays (e.g., liquid crystal displays—LCDs). An example is an e-tag with several lights that employs a switch which changes the blinking lights from pink to green, or which changes one pattern of lights to another, or in which the LCD could be switchable from a steady-on to a flashing mode, and so forth. A further example is an e-tag having an LCD that is programmable with messages changeable from “Help me please.” to “Just browsing.” An advantage of these articles is that the customer can change the level of service desired mid-shopping without going back to a display unit or a sales associate. A further advantage of e-tags is that they are customizable and/or reprogrammable. They may offer options so the user can change the service level desired, or request immediate assistance, by sending an audio or a radio (RFID) signal. A still further advantage of the use of an e-tag is that it may incorporate a locator system to track (e.g., on a computer screen) where in the area the customer is shopping, for example, where she spends most of her time. Badges consisting of electronic paper (“e-paper”) and/or electronic ink (used in e-readers), supported on a plastic substrate, for example, may also be used in the present method.

As discussed hereinabove, instructions for selecting and displaying the article may be provided by a sales associate. In other embodiments of the present invention, the article may be contained in a display unit, whether free-standing or placed on a store counter, so as to be readily accessible to the customer. Instructions for prominently displaying, or otherwise associating, the article on the person of the customer may be provided on, or otherwise in association with, the display unit, such as on a sign placed near the display unit, or on the article itself. Selecting the level of service on the article may be accomplished by any known switching means, such as, for example, a slide switch, a toggle switch, and the like, or by use of a touch screen. Once the service level is selected and the article displayed by the customer, their service needs will immediately be identified and communicated to the sales associate. It will be appreciated that part or all of method may be carried out substantially non-verbally; that is, with minimal or no interaction between the retail customer and the sales associate.

The shopper may wear, carry, or otherwise associate the article with herself by any means which will communicate to the sales associate the level of service desired by the shopper. Therefore, the article may be worn or carried such that it is visually discernible by the sales associate. It will also be recognized that the selected level of service may be auditorially communicated to and discernable by the sales associate, or that the article could transmit a radio signal detectable, for example, on a sales associate's computer screen. In those cases, the article need not be visually or prominently displayed. An advantage associated with articles useful in the method of the invention is that, depending on her changing moods or needs while shopping, a customer may readily adjust the service level designation on the article to communicate her current service needs without returning to either the display unit or to a sales associate.

As a further non-limiting example, a method according to the invention may involve three levels of service available to customers. A first level of service maybe one in which no interaction with a sales associate is desired, such as where the shopper is browsing leisurely, testing products, such as at interactive product bars or displays, and only wishes to interact with the sales associate if and when she desires to make a purchase—a substantially salesperson-free shopping experience. The shopper who wishes no interaction with a sales associate may also take advantage of access to a manual or computer-aided diagnostic tool, in particular, a computer-aided diagnostic tool which is designed to allow the customer immediate access to on-on-one service to identify her skin care concerns by browsing a computer-guided skin care analysis program and receiving a printout (or an email) with custom-fit recommendations, all by answering a few key questions. A second level of service available to customers may be one for those shoppers desiring express service from a sales associate, such as when the customer is short of time, and, for example, knows exactly what she wants. She may have used up a product and merely want to purchase more. She may have a question about her selection or the use of a product. For customers who have an abundance of time, a third type of service involving an extended interaction with a sales associate would be desirable. For these customers, a one-on-one consultation with a skin care specialist can provide the shopper with an expert skin care analysis, individualized recommendations for skin care and makeup products, and application techniques and tips.

In accordance with a third embodiment of the present invention, a system is provided for improving retail customer service by identifying and communicating to a sales associate the service needs of a retail customer in a retail setting, the system comprising:
(a) at least two articles, each of which is adapted to designate a different level of customer service which may be desired by the retail customer; and
(b) instructions directed to the retail customer to (1) select one of the at least two articles which best defines the service needs of the retail customer at the time of the selection, and (2) prominently display on, or otherwise associate the article with, the retail customer's person so as to communicate the retail customer's service needs to a sales associate and receive the desired level of customer service from the sales associate.

Useful articles may include, but are not limited to, wristbands, pins, tags, buttons, badges, lanyards, pendants, caps, hats, headbands, scarves, baskets, totes, charms attachable to a mobile device, cards attachable on a key ring, and the like. In a preferred embodiment of the invention, the articles are wristbands. In a further preferred embodiment of the invention, three articles, designating three different levels of customer service, are provided. In yet another preferred embodiment of the invention, the articles have different colors or shapes from one another, the different colors or the different shapes each designating a different level of service available to the customer. The articles may be further provided with text describing the retail customer's service needs.

In some embodiments of the systems of the invention, instructions for selecting and displaying the article may be provided by a sales associate. In other embodiments, the articles are contained in a display unit, which may be either free-standing, or placed on a store counter, so as to be readily accessible to the customer. Preferably, the display unit is provided with instructions, such as instructions printed on the display unit, which permit shoppers to self-select an article which, when prominently displayed by the shopper, will immediately identify their service needs and communicate those needs to the sales associate. Alternatively, instructions for prominently displaying, or otherwise associating, the article on the person of the customer may, for example, be provided on a sign placed near the display unit or on the article itself. It will be appreciated that use of the systems according to the present invention requires no or substantially no interaction between the retail customer and the sales associate.

It also will be appreciated that prominent display of the selected article by the shopper may includes wearing, carrying, or any other means, such that the article will be visible to the sales associate so as to communicate to the sales associate the level of service desired by the customer; that is, to either attract a sales associate or to fend off an enthusiastic sales associate, as needed. Depending on her changing mood or needs while shopping, a customer may readily return to the display unit or to a sales associate and exchange the article she displays for another which designates her current service needs.

As a non-limiting example, a system according to the present may include three levels of service. A first level of service may be one in which no interaction with a sales associate is desired, such as where the shopper is browsing leisurely, testing products at interactive product bars or displays, and only desires interaction with the sales associate if and when she wishes to make a purchase—a substantially salesperson-free shopping experience. The shopper who wishes to browse peacefully also may take advantage of access to a manual or computer-aided diagnostic tool, in particular, a computer-aided diagnostic tool which is designed to allow the customer immediate access to on-on-one service to identify her skin care concerns by browsing a computer-guided skin care analysis program and receiving a printout (or an email) with custom-fit recommendations, all by answering a few key questions. A second level of service may be one available to customers desiring express service from a sales associate, such as when the customer is short of time, and, for example, knows exactly what she wants. She may have used up a product and merely wants to purchase more. She may have a question about her selection or use of a product. An example of a third type of service could be available to customers who have an abundance of time, such as one in which an extended interaction with a sales associate would be welcomed. For these customers, a one-on-one consultation with a skin care specialist can provide the shopper with an expert skin care analysis, individualized recommendations for skin care and makeup products, and application techniques and tips.

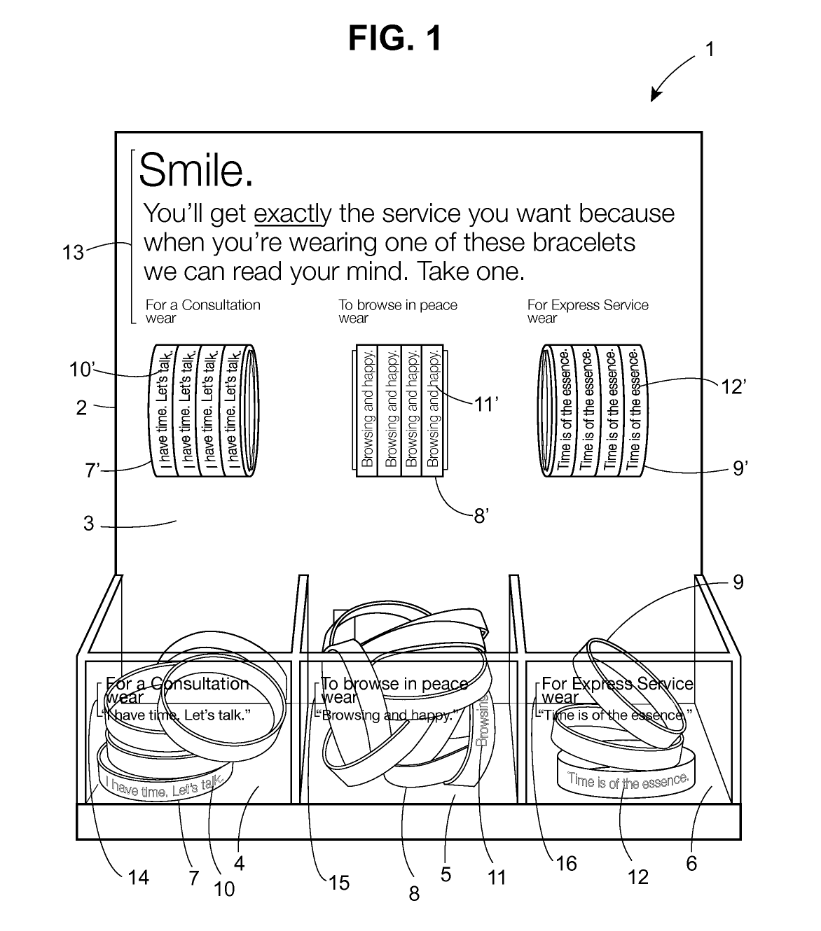

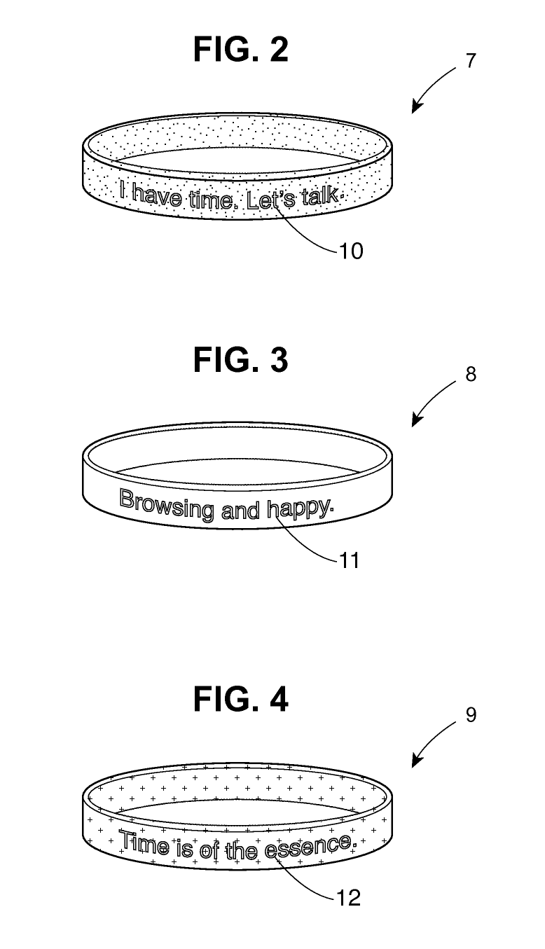

As an example of a system according to the present invention, reference is made to FIGS. 1-4. The system is shown generally at reference numeral 1. A housing 2 in the form of a display unit has a support 3 and three separated compartments, 4, 5 and 6. Compartment 4 holds wristbands 7, which designate a first level of customer service available to a shopper. Compartment 5 contains wristbands 8, which designate a second level of service. Compartment 6 holds wristbands 9, which designate a third level of service. Wristbands 7′, 8′ 9′ are affixed to support 3 for display purposes. The level of service is designated by the different colors of the wristbands. For example, wristbands 7, 7′ may be green, the color communicating to the sales associate that the shopper wishes to have a consultation; wristbands 8, 8′ may be pink, the color communicating to the sales associate that the shopper wishes to browse and have no interaction with a sales associate; and wristbands 9, 9′ may be white in color, the color communicating to the sales associate that the shopper is pressed for time and wishes immediate assistance. Additionally, each band is also imprinted with text which also designates the level of service. Wristbands 7, 7′ include the text 10, 10′: “I have time. Let's talk.” Wristbands 8, 8′ include the text 11, 11′: “Browsing and happy.” Wristbands 9, 9′ include the text 12, 12′: “Time is of the essence.” A block of text 13, providing instructions directing the retail customer to select and wear a wristband corresponding to her desired level of service, is printed on the display unit support 3. Blocks of text 14, 15, 16, associated with compartments 4, 5, 6, respectively, of display unit 1, include confirmation instructions to the customer and service level communications to the sales associate.

In accordance with a fourth embodiment of the invention, a system is provided for improving retail customer service by identifying and communicating to a sales associate the service needs of a retail customer in a retail setting, the system comprising:
(a) an article that is adapted to designate at least two different levels of customer service available to the retail customer;
(b) means associated with the article for enabling the retail customer to select one of the levels of customer service designated by the article which best defines the customer service needs of the retail customer at the time of the selection; and
(c) instructions directed to the retail customer to prominently display, or otherwise associate, the article designating the selected level of service with the retail customer's person so as to communicate the level of service desired by the retail customer to a sales associate and receive the desired level of service.

Articles useful in the system according to the invention may include any article, including those articles mentioned hereinabove, which has the capability of designating at least two levels of customer service. Any article that is switchable or flippable, such as a badge that is green on one side or pink on the other may be used. In particular, mention may be made of “e-tags”—electronic buttons, badges, tags, pins, for example, lapel pins, clutch pins, safety pins, and the like, with lights, light-emitting diodes (LEDs) in varying colors, or varying displays (e.g., liquid crystal displays—LCDs). Examples include an e-tag with several lights that employs a switch which changes the blinking lights from red to green, or which changes one pattern of lights to another, or in which the LCD could be switchable from a steady-on to a flashing mode, and so forth. A further example may be an LCD that is programmable with messages changeable from “Help me please.”, to “Just browsing.”. An advantage of these articles is that the customer can change the level of service desired mid-shopping without going back to a display unit or a sales associate. A further advantage of e-tags is that they are customizable and/or reprogrammable. They may offer options so the user can change the service level desired, or request immediate assistance, by sending an audio or a radio (RFID) signal. A still further advantage of the use of e-tags is that they may incorporate a locator system to track (e.g., on a computer screen) where in the area the customer is shopping, for example, where she spends most of her time. Badges consisting of electronic paper (“e-paper”) and/or electronic ink (used in e-readers), supported on a plastic substrate, for example, may also be used in the present system.

As discussed hereinabove, instructions for selecting and displaying the article may be provided by a sales associate. In other embodiments of the present invention, the article may be contained in a display unit, whether free-standing or placed on a store counter, and readily accessible to the customer. Instructions for prominently displaying the article on, or in association with the person of the customer may be provided on, or otherwise in association with, the display unit, such as on a well-placed sign. Instructions for selecting the level of customer service may be provided on the display unit or on the article itself Selecting the level of service on the article may be accomplished by any known switching means, such as, for example, a slide switch, a toggle switch, and the like, or by use of a touch screen. Once the service level is selected and the article displayed by the customer, her service needs will immediately be identified and communicated to the sales associate. It will be appreciated that use of the systems according to the present invention requires no or substantially no interaction between the retail customer and the sales associate.

The shopper may wear, carry, or otherwise associate the article with herself by any means which will communicate to the sales associate the level of service desired by the shopper. Therefore, the article may be worn or carried such that it is visually discernible by the sales associate. It will also be recognized that the selected level of service may be auditorially communicated to and discernable by the sales associate, or that the article could transmit a radio signal (RFID) which is detectable, for example, on the sales associate's computer screen, and in these cases, the article need not be prominently displayed. Depending on her changing mood or needs while shopping, a customer may readily adjust the service level designation on the article to communicate her current service needs without returning to either the display unit or to a sales associate. It will further be appreciated that systems according to the present invention may be adapted for use as an “app” for devices such as smart phones.

As a non-limiting example, the different levels of service available to customers, and designated by the article, may include three levels of service. A first level of service maybe one in which no interaction with a sales associate is desired, such as where the shopper is browsing leisurely, testing products, such as at interactive product bars or displays, and only desires interaction with the sales associate if and when she wishes to make a purchase—a substantially salesperson-free shopping experience. The shopper wishing no interaction with the sales team may take advantage of access to a manual or computer-aided diagnostic tool, in particular, a computer-aided diagnostic tool which is designed to allow the customer immediate access to on-on-one service to identify her skin care concerns by browsing a computer-guided skin care analysis program and receiving a printout (or an email) with custom-fit recommendations, all by answering a few key questions. A second level of service could be available to the shopper desiring express service from a sales associate, such as when the customer is short of time, and, for example, knows exactly what she wants. She may have used up a product and merely wants to purchase more. She may have a question about her selection or use of a product. An example of a third type of service available to customers who have an abundance of time, is one in which an extended interaction with a sales associate would be welcomed. For such customers, a one-on-one consultation with a skin care specialist can provide the shopper with an expert skin care analysis, individualized recommendations for skin care and makeup products, and application techniques and tips.

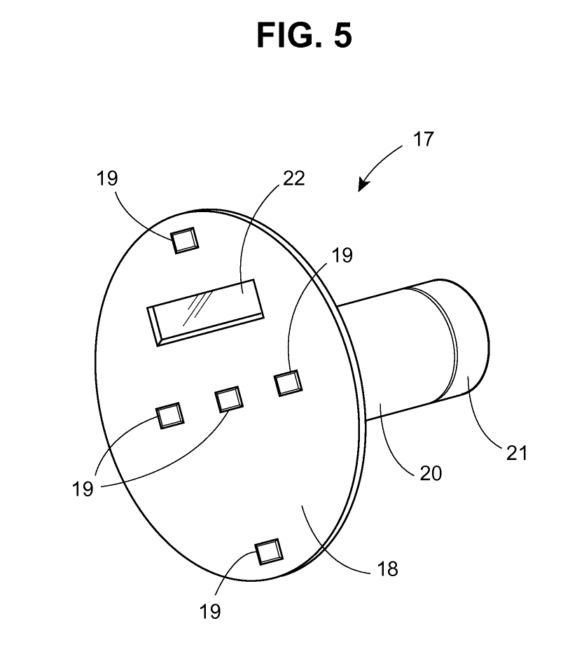

As a further example of a system according to the present invention, reference is made to FIG. 5. The system, in the form of a magnetic lapel pin, is shown generally at reference numeral 17. The magnetic lapel pin 17 includes a support 18. The support 18 is provided with LED lights 19. The lights 19 are programmable to change color to designate at least two levels of service available to the customer. The system also includes a housing 20 for a battery and magnetic means 21 for attaching the pin to the clothing, handbag, etc. of a customer. Touch screen 22 is provided on the support 18 to enable the customer to select a desired level of service.

It will be understood that the present invention may be used to identify and communicate a service need in any retail environment. Further the present invention may be used in advertising to depict the type or level of service or mood or feel of a product or service. The present invention may also be used to identify a mood or preference in a work environment or in a social setting, such as a party or at a bar.

While the subject invention have been described in various preferred embodiments, the skilled artisan will appreciate that various modifications, substitutions, omissions and changes may be made without departing from the spirit thereof

What is claimed is:

1. A system for improving retail customer service by identifying and communicating to a sales associate the service needs of a retail customer in a retail setting, the system comprising:
(a) at least two articles, each of which is adapted to designate a different level of customer service available to the retail customer; and
(b) instructions directed to the retail customer to (1) select one of the at least two articles which best defines the service needs of the retail customer at the time of the selection, and (2) prominently display on, or otherwise associate the article with, the retail customer's person so as to communicate the retail customer's service needs to a sales associate and receive the desired type of customer service from the sales associate.

2. The system of claim 1, wherein at least three articles, each designating a different level of customer service, are provided.

3. The system of claim 1, wherein the at least two articles and instructions for selecting and displaying one of the at least two articles are obtainable from a sales associate.

4. The system of claim 1, wherein the at least two articles are contained in a display unit.

5. The system of claim 4, wherein the display unit is provided with at least two compartments adapted to separately receive and contain the at least two articles.

6. The system of claim 1, wherein instructions for selecting and displaying one of the least two articles are associated with the display unit.

7. The system of claim 1, wherein each of the at least two articles has a color or a shape which is distinctly different from the color or shape of the other article.

8. The system of claim 1, wherein each of the at least two articles is further provided with text describing the retail customer's service needs.

9. The system of claim 1, wherein the at least two articles are selected from wristbands, pins, tags, e-tags, buttons, badges, lanyards, pendants, caps, hats, headbands, scarves, baskets, totes, charms attachable to a mobile device, and cards attachable on a key ring.

10. The system of claim 1, wherein the at least two articles are wristbands having distinctly different colors from one another.

11. The system of claim 1, wherein the at least two articles comprise three wristbands having distinctly different colors from one another.

12. The system of claim 2, wherein three levels of customer service are provided, a first level of customer service in which no interaction with a sales associate is desired, a second level of customer service in which express service from a sales associate is desired, and a third level of customer service in which an extended interaction with a sales associate is desired.

13. The system of claim 1, wherein steps (a) and (b) require no interaction between a customer and a sales associate.

14. A system for improving retail customer service by identifying and communicating to a sales associate the service needs of a retail customer in a retail setting, the system comprising:
(a) an article adapted to designate at least two levels of customer service available to the retail customer;
(b) means associated with the article for enabling the retail customer to select one of the at least two levels of customer service designated by the article which best defines the customer service needs of the retail customer at the time of the selection; and
(c) instructions directed to the retail customer to prominently display, or otherwise associate, the article designating the selected level of service with the retail customer's person so as to communicate the level of service desired by the retail customer to a sales associate and receive the desired level of service.

15. The system of claim 15, wherein the article is selected from wristbands, pins, tags, e-tags, buttons, badges, lanyards, pendants, caps, hats, headbands, scarves, baskets, totes, charms attachable to a mobile device, and cards attachable on a key ring.

16. The system of claim 15, wherein the article is contained in a display unit.

17. The system of claim 15, wherein instructions for selecting and displaying the article are associated with the display unit.

18. The system of claim 15, wherein the article is adapted to visually display a selected level of service.

19. The system of claim 15, wherein the article is adapted to designate the selected level of service by means of an auditory signal.

20. The system of claim 15, wherein the article is adapted to designate the selected level of service by means of a radio frequency signal (RFID).

21. The system of claim 15, wherein each of the at least two levels of customer service is designated by a display of indicia or an image which is differently colored from the indicia or image display designated by each other level of service.

22. The system of claim 15, wherein the levels of customer service are designated by switchable colors or patterns of lights.

23. The system of claim 15, wherein the article is an e-tag provided with LEDs, LCDs or both.

24. The system of claim 15, wherein selecting one of the at least two levels of customer service designated by the article comprises use of a toggle switch, a slide switch, or a touch screen.
